(19) United States
(12) Patent Application Publication
(10) Pub. No.: US 2002/0020461 A1
(43) Pub. Date: Feb. 21, 2002

(54) Powder supply system

(76) Inventor: Hans G. Platsch, Stuttgart (DE)

Correspondence Address: FACTOR & PARTNERS, LLC, 1327 W. WASHINGTON BLVD., SUITE 5G/H, CHICAGO, IL, 60607, US

(21) Appl. No.: 09/825,462

(22) Filed: Apr. 3, 2001

(30) Foreign Application Priority Data
Apr. 3, 2000 (DE) 10016552.4

(51) Int. Cl. B65G 53/40

(52) U.S. Cl. 141/153; 222/64

(57) ABSTRACT

A powder supply system (10) is used to supply at least one device (12) for dispensing powder, in particular a device for dusting printed materials. The powder supply system (10) has an intermediate powder supply container (40). This is connected to the powder dispensing device (12) via a powder feed device (70, 126, 128). An automatic supply of powder to the at least one powder dispensing device (12) is guaranteed by the powder supply system (10).

The invention relates to a powder supply system according to the preamble of claim 1.

In powder supply systems of this kind known from the market, a supply container of the powder dispensing device, which container is integrated into or immediately adjacent to the latter, is topped up with powder from welded bags. In a refilling process of this kind, however, it is unavoidable that powder escapes into the environment, resulting in impairment of the inhaled air and pollution. Other versions of known powder supply systems have portable supply containers with base valves, which can be filled in an adjacent room. Topping up of this kind is complicated and space-consuming.

The object of the present invention is therefore to develop a powder supply system of the type specified at the beginning in such a way that the powder dispensing device can be topped up automatically.

This object is achieved according to the invention by a powder supply system with the features stated in claim 1.

The at least one powder dispensing device is supplied automatically with powder from the powder supply container by means of the powder feed device. No intermediate refilling process is required here, in which powder can escape undesirably. In addition, the powder supply container can be arranged close to the powder dispensing device, simplifying the supply of powder and resulting in a compact powder supply system, in which the powder feed device together with the powder supply container is accommodated for example in a control cubicle.

Powder conveying with a powder feed device according to claim 2 is effected via a powder/air mixture in a conveying line. A powder feed device of this kind can be executed economically. Sealing of the conveying path here guarantees that no powder escapes into the environment during conveying.

A powder supply system according to claim 3 with a central source of conveying air is economical compared with systems with a plurality of powder feed devices, which each have their own source of conveying air.

A suction device according to claim 4 also gives rise to the possibility of preventing the escape of powder/air mixture wandering in the powder supply system into the environment.

A suction device according to claim 5 is quiet.

The use of a conveying air separator according to claim 6 results in efficient powder conveying to the powder dispensing devices, as the conveying air downstream of the powder dispensing device is substantially free of powder. In powder supply systems with open air circulation, provided that the powder is separated sufficiently completely, the conveying air can escape into the environment after the separator.

A fluidizing device according to claim 7 leads to improved flowability of the powder. It is then possible to use powder with a lower inherent pouring capacity.

The use of micropore bodies in the fluidizing device according to claim 8 leads to the possibility of supplying air to the powder in the powder supply container over a relatively large contact surface, so that good large-surface fluidization of the powder is guaranteed. The specified pore size of the micropore bodies prevents them from becoming clogged.

Powder conveying according to claim 9 has a high level of conveying efficiency.

This efficiency can be optimized by coordinating the dimensioning of the compressed air source and the powder feed line according to claim 10.

The design of the powder supply system according to claim 11 facilitates optional assignment of a powder dispensing device to a powder feed device. The powder flow distributor can also be used e.g. in such a way that following emptying of one powder supply container, a full powder supply container can be switched to.

With the powder flow distributor according to claim 12, it is possible to supply one powder dispensing device from several powder supply containers. This is utilized to use a plurality of different powder types, which are coordinated to certain applications of the powder dispensing device.

The construction of the powder flow distributor by means of two distributor parts moved against one another according to claim 13 is particularly simple.

A second distributor part executed according to claim 14 guarantees that those powder dispensing ducts which belong to powder dispensing devices to which no powder is to be conveyed are securely closed and that therefore no powder/air mixture can escape from the related powder dispensing ducts of these powder dispensing devices.

The tightness between the distributor parts is improved still further by the execution according to claim 15.

A powder flow distributor according to claim 16 can connect a plurality of powder dispensing devices and powder supply containers respectively optionally with one another in a simple and compact structure.

In this case, a drive according to claim 17 is particularly simple.

A second distributor part according to claim 18 results in the possibility of closing a plurality of powder feed devices by means of a quickly executable displacement movement between the distributor parts with a small switching operation, or of releasing these again for powder conveying.

The execution according to claim 19 is economical in a powder supply system with several powder dispensing devices, as the main components of the powder feed device, e.g. the conveying air source, do not have to be present severally, but can be executed centrally.

A refilling-conveying device according to claim 20 guarantees automatic topping up of the powder supply container. The powder supply container can then be executed relatively compactly, due to which the powder stored in it is compressed only slightly by the force of gravity. The latter results in a further improvement in the flowability of the powder.

A suction device according to claim 21 leads to the possibility of filling the powder supply container quickly and efficiently from the supply container of the refilling-conveying device. The execution in which the suction device of the refilling-conveying device is at the same time the one provided for returning the conveying air from the powder feed devices is particularly advantageous. The suction device can also be executed centrally even in powder supply systems with several powder dispensing devices.

Alternatively, conveying without air discharge is guaranteed by a refilling-conveying technique according to claim 22.

A flexible screw conveyor according to claim 23 leads even here to the possibility of a variable and compact design of the refilling-conveying device.

A refill control valve according to claim 24 guarantees that a refilling-conveying device can be controlled by opening or closing a conveying line. This is particularly advantageous if e.g. a drive of the refilling-conveying device, e.g. a source of negative pressure or vacuum pump, which sets the powder in motion, is used in operation of the powder supply system for other purposes as well as refilling, e.g. for back-flushing, return or removal by suction, so that refilling-conveying cannot be controlled via operating or turning off of the drive.

A refill control valve according to claim 25 guarantees secure closing of the conveying line.

A conveying lance according to claim 26 guarantees reliable and complete emptying of the powder refill supply container.

Here a secondary air opening according to claim 27 prevents the conveying line behind the conveying lance from becoming clogged by powder accumulations.

An inlet opening according to claim 28 facilitates emptying of an inclined powder refill supply container with as little residue as possible.

A plug-in connector according to claim 29 enables quick connection or release of a powder dispensing device to or from the conveying components of the powder supply system.

This is particularly advantageous if the powder feed device and the powder supply container are accommodated in a control cubicle, to which a powder dispensing device can be connected.

A powder separating device according to claim 30 prevents powder from being deposited in the suction device. In addition, the possibility is created of a closed powder circuit in the powder supply system for returning powder remaining in the conveying line of the powder dispensing device, due to which the undesirable escape of powder is prevented even more effectively and this can be reused. A conveying air separator can then be designed to increase the air throughput such that a limited amount of powder can remain in the conveying air downstream of the powder dispensing devices. This is then returned in a controlled manner and cannot penetrate outside. The conveying air separator then has no great flow resistance.

Lines according to claim 31 are compact and make it simple to execute the plug-in connectors optionally provided.

A powder collecting vessel according to claim 32 can be used for intermediate storage of returned powder.

The suction effect of the return device for conveying air containing powder can be coordinated to the conveying quantity with the aid of a throttle valve according to claim 33.

A throttle valve according to claim 34 is particularly simple.

Here a flap according to claim 35 guarantees that the conveying line can be tightly closed if necessary.

Powder returned with the conveying air is separated efficiently with a filter according to claim 36 and clogging of the suction device avoided.

In this case, filter executions according to claim 37 have a large active filter area, due to which their life and separating capacity are improved.

A flush-back device according to claim 38 guarantees filter cleaning without the filter having to be removed.

Utilization of the compressed air source both for back-flushing of the filter and to convey the powder according to claim 39 is particularly efficient.

Back-flushing can take place with a shut-off valve according to claim 40 without an air flow or blast of compressed air used in this process swirling the powder in the powder refill supply container. When the shut-off valve is closed, the suction capacity available for the return of conveying air containing powder is increased, and the volume of the powder supply container is not additionally drained by suction, so that the powder dispensing operation can be carried out without interruption.

The arrangement of the separator according to claim 41 results in separated powder falling to the powder supply container. Shutting off of a line path with a relatively large cross-section is also guaranteed securely with the shut-off valve according to claim 41.

A shut-off valve according to claim 42 can operate automatically.

Powder conveying lines according to claim 43 prevent powder collecting in them undesirably. The flexibility of the powder conveying lines is particularly advantageous in connection with a powder flow distributor with moving components and with regard to a simple line layout which is free of abrupt changes in direction.

By means of a controller according to claim 44, both the refilling process in the powder supply container and the powder supply to the powder dispensing device as well as any powder flow distribution from several intermediate supply containers if applicable to several powder dispensing devices if applicable can be controlled automatically. Back-flushing of the filter for cleaning the conveying air sucked back, the removal by suction of conveying air containing powder from the powder dispensing device and the fluidization of the powder can also be controlled automatically thereby. In addition, the supply container which is to be emptied using the conveying lance can be selected by means of the controller. A new, full supply container can thus be selected automatically following the emptying of a supply container. Changing between supply containers containing powder of different quality or composition is also possible thereby.

Flexible adaptation to various modes of operation of the powder supply system is possible with a controller according to claim 45.

A level sensor according to claim 46 can be connected e.g. to acoustic or optical signal transducers, which then become active if preset tolerance limits of the monitored level are left.

Level sensors according to claims 47 and 48 are precise and yet economical.

Monitoring of the emptying of a powder refill supply container without residue is possible with a level sensor according to claim 49.

Control signals can be generated with level sensors according to claim 50, which signals are processed in the controller, in order to initiate e.g. refilling or powder supply or a change of powder refill supply container.

The invention is explained in greater detail below with reference to practical examples, with reference to the drawing. In this,

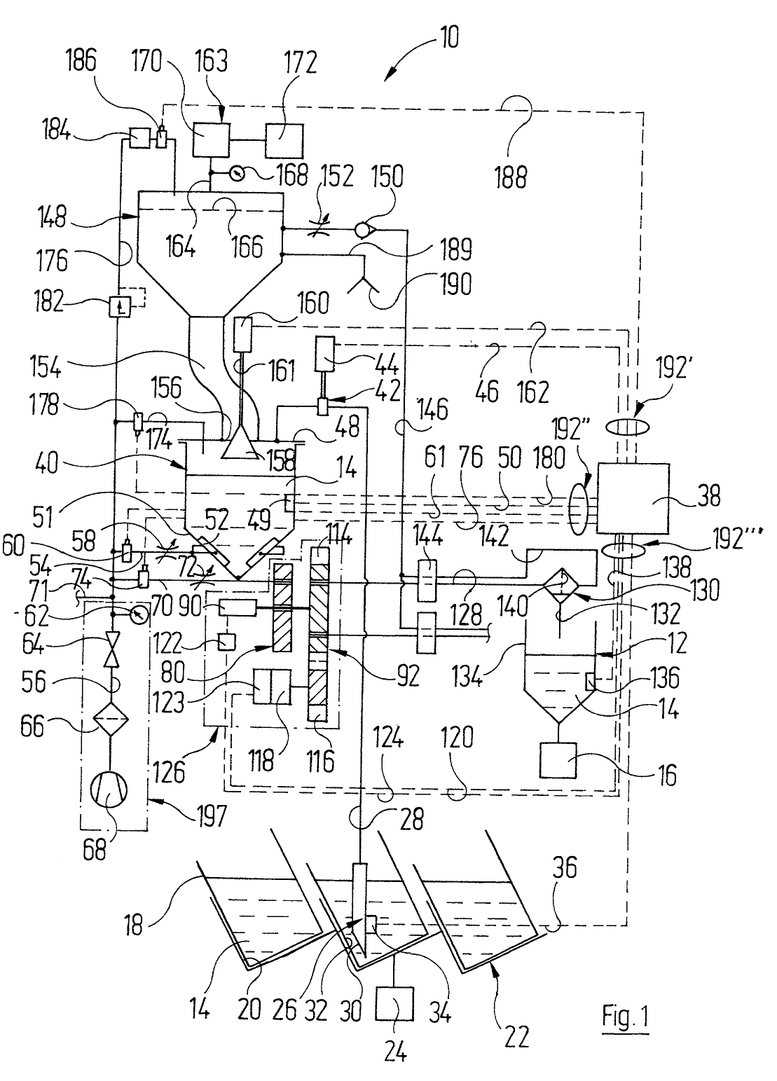

FIG. 1 shows an overview of a powder supply system;

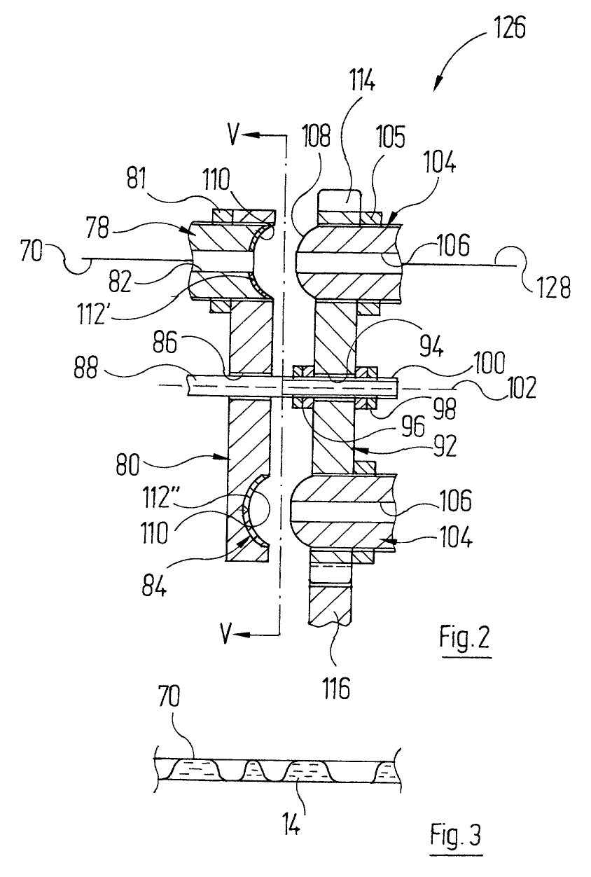

FIG. 2 shows a section through a powder flow distributor of the powder supply system in FIG. 1, showing further details;

FIG. 3 shows a section of a pressure conveying line of the powder supply system in FIG. 1;

FIG. 4 shows a view according to line V-V in FIG. 2;

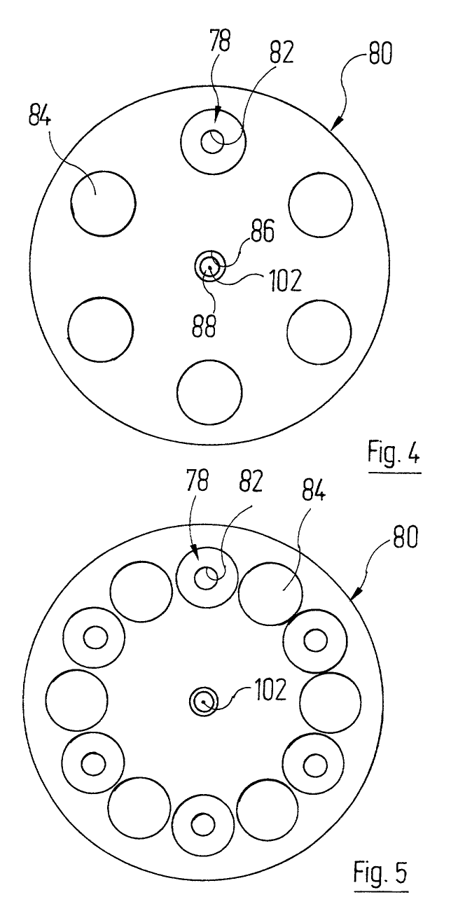

FIG. 5 shows a similar view to FIG. 4 of an alternative practical example of a powder flow distributor;

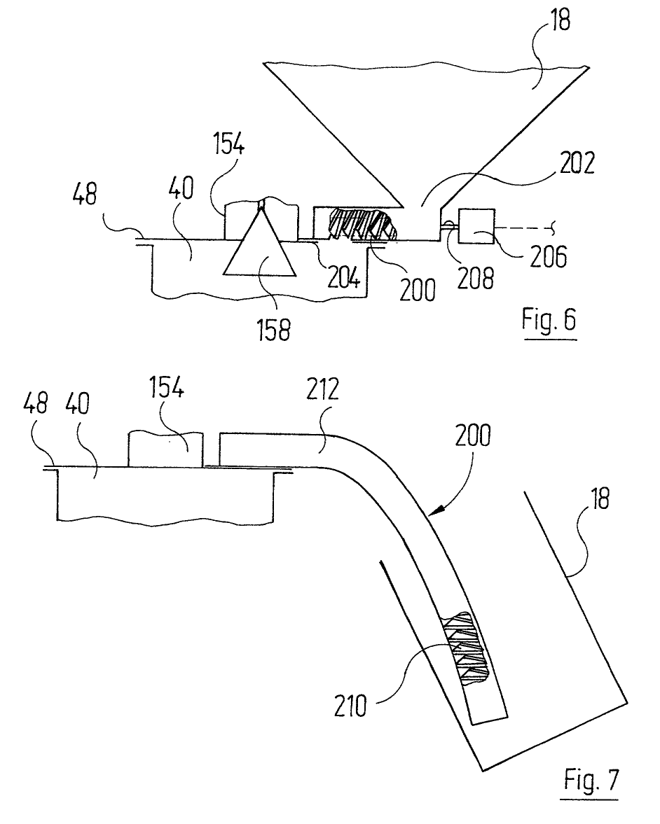

FIG. 6 shows a refilling-conveying device which can be used alternatively in a powder supply system; and

FIG. 7 shows a further refilling-conveying device which can be used alternatively in a powder supply system.

A powder supply system provided as a whole with the reference symbol 10 in FIG. 1 supplies a plurality of powder dispensing devices, of which the powder dispensing device 12 is shown representatively in FIG. 1, with powder 14. The latter is dispensed from a nozzle bar 16 with a plurality of powder nozzles aligned at a distance onto fresh printed materials (not shown in the drawing), which are conveyed past under the powder dispensing device 12, so as to avoid sticking of these materials during subsequent stacking of the same.

The powder 14 is supplied by the manufacturer in powder supply containers 18. These are drums of the size of a box containing approx. 30 kg. A plurality of powder supply containers 18, three in FIG. 1, are placed in inclined receptacles 20 of a container stand 22. Due to this inclined position, the powder supply containers 18 are held securely in the container stand 22 and have a predetermined lowest point. So that during powder removal the powder 14 can trickle down to the bottom of the powder supply container 18, the container stand 22 is made to vibrate by means of an electric vibrator 24, to which it is connected mechanically.

In the middle container of the three powder supply containers 18, a conveying lance 26 is shown. This is hollow and is in fluid contact with a suction conveying line 28, which has an inner diameter of approx. 20 mm.

The end of the conveying lance 26 reaching almost to the bottom of the middle powder supply container 18 has a bevel 30, so that the conveying lance 26 can suck out the powder 14 right down to the lowest-lying area of the powder supply container 18. For this purpose, the inclination of the bevel 30 is such that it is substantially parallel to a side wall 32 of the powder supply container 18 facing the bevel 30. The bevel 30 also leads to the inlet opening of the conveying lance 26 (not shown in FIG. 1) being enlarged in cross-section. Clogging of the conveying lance 26 with powder is prevented by a supplementary air duct of the conveying lance 26 (not shown in FIG. 1), which duct emerges from an upper section of the conveying lance 26 and is in fluid contact with the suction conveying line 28.

A level sensor 34, e.g. a light barrier or capacitive sensor, is fitted to the conveying lance 26. This is connected via a signal line 36 to a supply controller 38 of the powder supply system 10, the function of which is yet to be described below.

The suction conveying line 28 connects the conveying lance 26 to an intermediate powder supply container 40 and can be closed off via a refill control valve 42. The latter is a valve formed as a ball valve, which is operated mechanically by a lifting cylinder 44. Alternatively to a ball valve, a solenoid valve can also be provided. The lifting cylinder 44 is connected via a signal line 46 to the supply controller 38. The suction conveying line 28 opens into the intermediate powder supply container 40 via a cover plate 48.

Disposed on the inner wall of the intermediate powder supply container 40 is a level sensor 49, which is connected via a signal line 50 to the supply controller 38.

The intermediate powder supply container 40 has a bottom wall 51 progressing in a funnel shape at its base. Inside the intermediate powder supply container 40, a plurality of micropore bodies 52 is attached to air chambers of the bottom wall 51, two of the plate-shaped micropore bodies 52 supported by the bottom wall 51 being illustrated in FIG. 1. These have an open-pored structure of a typical pore size, which is smaller than the typical grain size of the powder 14.

The air chambers provided with the micropore bodies 52 are connected via line sections led out of the intermediate powder supply container 40 via a micropore body main line 54 to a central pressure line 56. Disposed in the micropore body main line 54 upstream of the line sections assigned to the micropore bodies 52 are a throttle valve 58 and a solenoid valve 60. The latter is connected via a signal line 61 to the supply controller 38.

Disposed in the central pressure line 56 upstream of the branching point to the micropore body main line 54 and other pressure lines yet to be described are a pressure gauge 62, a main shut-off valve 64 and a filter 66.

A compressor 68 connected to the central pressure line 56 upstream of the filter 66 serves as a source of compressed air for the central pressure line 56.

The outlet of the intermediate powder supply container 40 at the lowest point of the bottom wall 51 exits into a powder feed line 70, via which it is in fluid contact with the central pressure line 56. Disposed in the powder feed line 70 between the branching point off the central pressure line 56 and the outlet of the intermediate powder supply container 40 are a throttle valve 72 and a solenoid valve 74. The latter is connected via a signal line 76 to the supply controller 38.

Downstream of the outlet of the intermediate powder supply container 40, the powder feed line 70 issues into a dispensing bushing 78 (cf. FIGS. 2 and 4). The dispensing bushing 78 is screwed into a distributor end part 80, which is shown in greater detail in FIGS. 2 and 4 and the function of which is yet to be described, and fixed by means of a locknut 81.

Apart from the powder feed line 70, further powder feed lines are connected to the central pressure line 56, of which the powder feed line 71 is shown representatively in FIG. 1, which lines connect the central pressure line 56 to further intermediate powder supply containers (not shown). These are connected in the same manner to components for powder supply such as the intermediate powder supply container 40 and are not described further, therefore.

The distributor end part 80 has a total of six bushings yet to be described, which are arranged like the cartridge chambers of a drum revolver (cf. FIG. 4). Only one of these bushings, namely the dispensing bushing 78, has a line opening 82, which creates a fluid connection to the powder feed line 70, as illustrated diagrammatically in FIG. 2. The other bushings of the distributor end part 80 are blind bushings 84, which have no line opening.

The distributor end part 80 has a central axial opening 86, through which a piston rod 88 of a lifting cylinder 90 (cf. FIGS. 1 and 2) is guided. Both the lifting cylinder 90 and the distributor end part 80 are connected fixedly to a frame of the powder supply system 10 not shown in the drawing.

The end of the piston rod 88 is connected for the purpose of common axial movement to a distributor drum 92, but twistably in relation to this. For this, the end of the piston rod 88 is inserted through a central opening 94 in the distributor drum 92. Pairs 96, 98 of locknuts, which are screwed against one another on both sides of the distributor drum 92 on an end threaded section 100 of the piston rod 88, form the said axial coupling of the distributor drum 92 with the piston rod 88 and at the same time an axial bearing for twisting of the distributor drum 92 around an axis of rotation 102 coinciding with the axis of the piston rod 88.

The distributor end part 80 and the distributor drum 92 have a sixfold symmetry around the axis of rotation 102, apart from the fact that only one dispensing bushing 78 is arranged in the distributor end part 80.

The distributor drum 92 has a total of six powder dispensing bushings 104. These are arranged on the rotationally symmetrical distributor drum 92 as complementary components of the bushings 78 and 84 of the distributor end part 80, i.e. similarly to the cartridge chambers of a drum revolver. The powder discharge bushings 104 are screwed into the distributor drum 92 and fixed by means of locknuts 105. Each powder dispensing bushing 104 has a central conveying line section 106. The conveying line sections 106 are located at the same radial distance from the axis of rotation 102 as the centres of the bushings 78 and 84 of the distributor end part 80.

The conveying line sections 106 of the powder dispensing bushings 104 of the distributor drum 92 open in the direction of the distributor end part 80 in domes 108. The bushings 78 and 84 of the distributor end part 80 have troughs 110 complementary to the domes 108 and facing these. Inserted into the troughs are sealing bodies of elastic material, e.g. rubber or silicone. The sealing body 112′, which is assigned to the dispensing bushing 78, has a central opening aligned with the line opening 82, while the remaining sealing bodies 112″, which are assigned to the blind bushings 84, have no such openings.

If the differences in the executions of the sealing bodies 112′ and 112″ are not important below, they are described commonly by the reference symbol 112.

The circumferential wall of the distributor drum 92 is executed as a toothed wheel 114. A drive pinion 116 of an electric motor 118 engages in this (cf. FIG. 1).

The electric motor 118 is connected via a signal line 120 to the supply controller 38. The lifting cylinder 90 is connected via a position indicator 122 and a signal line 124 to the supply controller 38. Angle of rotation limitation of the electric motor 118 is realized by means of the position indicator 123 or a limit switch, which is coupled to the shaft of the electric motor 118, such that the distributor drum 92 can turn from a starting position by a maximum of 180° in both directions.

A powder dispensing device 12 is assigned to each powder dispensing bushing 104 of the distributor drum 92. The components of the powder supply system 10 arranged following the powder dispensing bushings 104 are identical for all powder dispensing devices 12, so that those components of the powder dispensing bushing 104 which are aligned with the dispensing bushing 78 in FIGS. 1 and 2 are described representatively here.

The distributor end part 80, the distributor drum 92 and the lifting cylinder 90 with its position indicator 122 and the electric motor 118 form a powder flow distributor 126 of the powder supply system 10.

The powder flow distributor 126, which represents a main component of the powder supply system 10, which component can be composed of individual components in the detailed illustration in FIG. 1, is bordered there by a block with dotted and dashed limiting lines.

The conveying line section 106 of the powder dispensing bushing 104 is in fluid contact with a conveying line 128, which connects the distributor drum 92 to the powder dispensing device 12 (cf. FIGS. 1 and 2). Disposed at the end of the conveying line 128 adjacent to the powder dispensing device 12 is a conveying air separator 130. The powder separated in this is supplied via a line section 132 to a powder dispensing vessel 134 of the powder dispensing device 12.

Mounted on the inner wall of the powder dispensing vessel 134 is a level sensor 136, which is connected via a signal line 38 to the supply controller 38. The powder dispensing vessel 134 exits like the intermediate powder supply container 40 in the shape of a funnel into an outlet, which is in fluid contact with the nozzle bar 16.

Arranged in the conveying air separator 130 is a microfilter 140, which is only permeable to a small extent for powder. The area of the separator 130 located downstream of the microfilter 140 is in fluid contact with a suction return line 142. The latter is combined between the conveying air separator 130 and a plug-in connector 144 assigned to the powder dispensing device 12 with a section of the conveying line 128 as a coaxial line, the conveying line 128 being encompassed by the suction return line 142, which has an internal diameter of 50 mm. This coaxial line is plugged detachably into the plug-in connector 144, so that the powder dispensing device 12 can be separated easily from the other components of the powder supply system.

With reference to the suction return line 142 downstream of the plug-in connector 144, the suction return line 142 separates from the conveying line 128 and opens, like the suction return lines of the other powder dispensing devices connected to the distributor drum 92, into a main suction return line 146. This connects the suction return line 142 to a separator 148. Disposed in the main suction return line 146 is a non-return valve 150, which permits an air flow from the powder dispensing device 12 in the direction of the separator 148. Also arranged in the main suction return line 146 is an adjustable throttle valve 152. This is executed as a felt-covered flap, which can be swivelled manually or by a servo drive in the main suction return line 146 (not shown in the drawing).

Similar to the intermediate powder supply container 40, the separator 148 has a base progressing in the shape of a funnel, which base exits into a connecting pipe 154. The latter creates a fluid connection between the separator 148 and the intermediate powder supply container 40 and opens into a central lid opening 156 in the cover plate 48 of the intermediate powder supply container 40.

The lid opening 156 can be closed by means of a shut-off valve 158 arranged inside the intermediate powder supply container 40, with a valve body widening in a cone shape in the direction of the intermediate powder supply container 40. To do this, the shut-off valve 158 can be displaced along the central axis of the lid opening 156 by means of a lifting cylinder 160 mounted frame-fixedly outside the connecting pipe 154. A piston rod 161 running along this axis and connected to the tip of the valve body, which rod connects the shut-off valve 158 to the lifting cylinder 160, is led through the wall of the connecting pipe 154 and out of this in an airtight manner. The lifting cylinder 160 is connected via a signal line 162 to the supply controller 38.

A suction device 163, which is in fluid contact with the separator 148 via a suction line 164, serves as a source of negative pressure for the main suction return line 146 and, via the intermediate powder supply container 40 and the connecting pipe 154, for the suction conveying line 28. The suction device 163 produces a negative pressure in the suction conveying line 28 and in the suction return line 142 of approx. 50 to 100 mbar. A subspace of the separator 148 connected directly to the suction device 163 via the suction line 164 is separated from the subspace of the separator 148 into which the main suction return line 146 and the connecting pipe 154 issue by a microfilter 166. The latter is impermeable to powder. The microfilter 166, which is indicated only diagrammatically in FIG. 1, is executed as a cylindrical filter membrane with a circumferential wall with multiple folds axially as a chamber filter or as a pocket or hose filter, so that a large filter surface is obtained.

A pressure gauge 168 is connected to the suction line 164.

The negative pressure source of the suction device 163 is a suction fan 170. This is provided on the outlet side with a silencer 172.

As well as the powder feed lines 70, 71 and the micropore body main line 54, the compressor 68 supplies another powder advance pressure line 174 and a flush-back pressure line 176 via the central pressure line 56.

The powder advance pressure line 174 connects the central compressed air line 56 to an upper subspace of the intermediate powder supply container 40. Disposed in the powder advance pressure line 174 is a solenoid valve 178, which is connected via a signal line 180 to the supply controller 38.

Disposed in the flush-back pressure line 176 one after another in the direction of the separator 148 are a pressure control valve 182, an accumulator 184 and a solenoid valve 186. The latter is connected via a signal line 188 to the supply controller 38.

Via additional suction lines, of which one is illustrated by 189, which is connected closably (not shown) to the separator 148 and exits into a suction hood 190, a casing (not shown) enclosing the powder supply device 10 or the environment of the powder dispensing devices 12 can be drained by suction, to remove residual powder present there.

The function of the powder supply system 10 is as follows:

A powder conveying system, which comprises all the fluid components which have been described in connection with FIGS. 1 and 2 and 4, is connected via a signal line bundle 192′, 192″, 192′″ to the supply controller 38. The signal line bundle 192 comprises the signal lines 36, 120, 124, 50, 61, 76, 180, 46, 162 and 188.

When the level sensor 49 of the intermediate powder supply container 40 actuates refilling, the suction device 163 takes in powder (and additional air) from the powder supply container 18 via the suction conveying line 28, the upper section of the intermediate powder supply container 40, the connecting pipe 154 and the separator 148. Under the influence of gravity and owing to the change in direction of the air in the upper section of the intermediate powder supply container 40, the powder 14 taken in with the air remains behind in the intermediate powder supply container 40 and slides there in the direction of the outlet in the bottom wall 51.

To convey the powder 14 stored in the interim in the intermediate powder supply container 40 to the individual powder dispensing devices 12′, 12″, the compressor 68 acts as a source of compressed air.

A portion of the compressed air supplied by the compressor 68 is supplied here to the micropore bodies 52 by opening of the solenoid valve 60 (cf. FIG. 1). The compressed air emerging from these into the intermediate powder supply container 40 and mixing with the powder 14 lying there results in fluidization of the powder 14, so that this does not form lumps and has adequate flowability for subsequent conveying.

The powder dispensing device 12′, 12″ to which powder is to be conveyed is selected by the powder flow distributor 126. To do this, the distributor drum 92, which for the moment is axially distanced from the distributor end part 80, is turned by means of the electric motor 118 until the powder dispensing bushing 104 of the conveying line 128 of the selected powder dispensing device 12 lies opposite the dispensing bushing 78 of the powder feed line 70. The distributor drum 92 is then drawn in the direction of the distributor end part 80 with the aid of the lifting cylinder 90 until the domes 108 come to rest on the troughs 110, the sealing bodies 112 sealing the conveying line sections 106 and the line opening 82 externally in the area of the powder flow distributor 126.

The powder is conveyed from the outlet of the intermediate powder supply container 40 to the conveying air separator 130 following opening of the solenoid valve 74 as plug transportation. This type of powder transportation is illustrated in FIG. 3:

Powder 14 removed from the intermediate powder supply container 40 to the powder feed line 70 collects in the lines running horizontally (powder feed line 70, conveying line 128), until the cross-section of these lines is closed by an accumulation of powder 14, i.e. one or more plugs. These plugs are moved through the lines under the influence of the compressed air. The pressure in the line, the flow velocity of the air and the line cross-sections of the powder feed line 70 and the conveying line 128, which are 8 mm in the present practical example, are coordinated to one another to optimize the conveying capacity. In the case of a conveying distance to be covered of up to 50 m by means of plug transportation in the feed line 70 and the conveying line 128, a conveying excess pressure of approx. 0.2 to 0.5 bar is present in the lines 70 or 128.

If the parameters of pressure, flow velocity and line cross-section are optimized, the result is that the velocity of the powder in plug transportation is roughly half as great as the flow velocity of the compressed air.

The majority of the powder 14 is separated in the conveying air separator 130 from the conveying air and supplied to the powder dispensing device 12 via the line section 132. A small portion of the powder 14 passes through the microfilter 140 in the conveying air separator 130, as the microfilter 140 is chosen not to be completely impermeable to powder 14, to guarantee a good air throughput. The portion of the powder 14 passing through the microfilter 140 is sucked by means of the suction device 163 into the separator 148 via the main suction return line 146. The powder 14 separated there falls under the influence of gravity through the connecting pipe 154 into the intermediate powder supply container 40. Complete separation of the conveying air and powder 14 takes place using the microfilter 166 in the separator 148.

To prevent clogging of the microfilter 166, this is subjected from time to time to back-flushing. A flush-back device is used for this purpose, which device is connected via the flush-back pressure line 176 to the compressor 68 and to the separator 148. The flush-back device comprises the pressure control valve 182, the accumulator 184 and the solenoid valve 186.

During back-flushing, the shut-off valve 158 is closed and the solenoid valve 186 opened intermittently, so that a blast of compressed air from the accumulator 184 is exerted in each case on the microfilter 166 in the opposite direction to the suction direction otherwise. In this process, powder 14, which has settled on the microfilter 166, is blown off, so that the microfilter 166 becomes free once more.

The non-return valve 150 here prevents a powder/compressed air mixture from being pushed into the main suction return line 146. Owing to the closed shut-off valve 158, the blast of compressed air does not cause swirling of the powder 14 in the intermediate powder supply container 40.

The taking of powder 14 from the intermediate powder supply container 40 in plug transportation to the powder dispensing device 12 can optionally also be supported in that compressed air presses from above onto the powder volume in the intermediate powder supply container 40 and thereby supports the influence of gravity. For this purpose, the solenoid valve 178 is opened with the shut-off valve 158 closed, so that the intermediate powder supply container 40 is put under pressure via the powder advance pressure line 174.

Disposed in the container stand 22 is a plurality of powder supply containers 18 (cf. FIG. 1). Central supply container storage of this kind can be utilized in various ways:

In a first embodiment, the conveying lance 26 is movable relative to the container stand 22 such that it can dip alternatively into each of the powder supply containers 18. The powder supply container into which the conveying lance 26 dips is then emptied during operation of the powder supply system 10 until the level sensor 34 responds and indicates that this powder supply container 18 is empty. The conveying lance 26 is then withdrawn from this powder supply container 18 and dipped into another, full powder supply container 18. The empty powder supply container 18 can now be exchanged for a full one.

In an alternative option for use of a container stand 22 with several powder supply containers 18, the individual powder supply containers 18 have powder 14 of different kinds. The powders 14 can vary here in their grain size, grain size distribution, in their material or in other parameters. Depending on the printed material to be dusted, the powder supply container 18 with the type of powder 14 specified for this is selected via the movable conveying lance 26.

In a further alternative option for using several powder supply containers 18, a conveying lance 26 of a different intermediate powder supply container 40 is assigned to each powder supply container 18. Here the supply container store on the container stand 22 serves as a central store for a plurality of the powder supply systems 10 shown in FIG. 1.

In a further alternative embodiment, several intermediate powder supply containers 40 can be connected to at least one powder dispensing device 12 via a powder flow distributor 126. A variant of a distributor end part 80 of this kind for six intermediate powder supply containers 40 and six powder dispensing devices 12 is shown in FIG. 5:

Here six dispensing bushings 78 are arranged in the style of cartridge chambers in a revolver. A blind bushing 84 lies in each case between two adjacent dispensing bushings 78, so that in this variant of the distributor end part 80 there are 12 bushings in total, which are each located at the same radial distance from the central axis of rotation 102 of the distributor end part 80.

With a distributor end part 80 of this kind, two principal positions can be realized in combination with a distributor drum 92, which has six powder dispensing bushings arranged in the manner of cartridge chambers, i.e. is constructed identically to that shown in FIGS. 1 and 2:

In a first position, the six line openings 82, which are assigned to the respective intermediate powder supply containers 40, are aligned with the conveying line sections 106, which are assigned to the corresponding powder dispensing devices 12. Due to opening of the respective solenoid valves 74 activated by the supply controller 38, plug transportation from the six intermediate powder supply containers 40 to the six powder dispensing devices 12 is now possible. If only the corresponding solenoid valve 74 is opened for plug transportation, no powder conveying takes place to the other five powder dispensing devices 12.

By turning the distributor drum 92 by 30° around the axis of rotation, the distributor drum 92 and the distributor end part 80 are aligned in relation to one another such that a blind bushing 84 now lies opposite the powder dispensing bushings 104 in each case. All six conveying lines 128 can be closed quickly in this way via the electric motor 118 and the lifting cylinder 90 owing to the small movement path required.

The possibility of utilizing the distributor end part 80 shown in FIG. 5 can be further expanded by having each of the six intermediate powder supply containers 40 filled with powder of a different quality. By turning the distributor drum 92 appropriately relative to the distributor end part 80, the desired dispensing bushing 78 of the intermediate powder supply container 40 can be assigned to the powder dispensing bushing 104 of a selected powder dispensing device 12, so that the desired type of powder can be supplied. If only the corresponding solenoid valve 74 is opened for plug transportation, no powder is conveyed to the other five powder dispensing devices 12.

In alternative embodiments, shown in FIGS. 6 and 7, the powder is conveyed to the intermediate powder supply container 40 not with the aid of the suction device 163, but via a feed screw 200:

In the practical example shown in FIG. 6, the powder supply container 18 is arranged above the intermediate powder supply container 40 adjacent to the connecting pipe 154. The powder supply container 18 runs here on the bottom side in the shape of a funnel to an outlet area 202. There the powder is conveyed by the feed screw 200 to an inlet 204 of the intermediate powder supply container 40 formed in the cover plate 48. The feed screw 200 is driven by an electric motor 206, the drive shaft 208 of which is led in a pressure-sealed manner out of the common casing of the powder supply container 18 and the feed screw 200. Alternatively, several supply containers can even be arranged distributed in a star shape around the connecting pipe 154, from which containers powder is conveyed in the same way into the intermediate powder supply container 40.

In the further alternative, which is shown in FIG. 7, the powder supply container 18 is arranged with reference to the intermediate powder supply container 40 and constructed as shown in FIG. 1. The stock is conveyed in this case by means of a flexible feed screw 200, which comprises a flexible screw conveyor 210 in a likewise flexible conveying tube 212. A drive motor for the feed screw 200 is not shown in FIG. 7; this can be provided at one end of the conveying tube 212.

The supply controller 38 processes the signals arriving from the level sensors 34, 50 and 136 and controls the powder supply by actuating the various solenoid valves, lifting cylinders and electric motors, as described above. It has proved favourable here to top up the stock in the intermediate powder supply container 40 intermittently in portions of 200 g in each case. This portioned conveying is preset under the control of the level sensor 49 in the intermediate powder supply container 40, which sensor is connected via the signal line 50 to the supply controller 38. The latter for its part activates the lifting cylinder 44 for the shut-off valve 42 and the lifting cylinder 160 for the shut-off valve 158.

1. Powder supply system (10) for supplying at least one device (12) for powder dispensing, in particular for dusting printed materials, characterized by a powder supply container (40), which is connected to the powder dispensing device (12) via a powder feed device (70, 126, 128).

2. Powder supply system according to claim 1, characterized in that the powder feed device (70, 126, 128) has a source of conveying air (68).

3. Powder supply system according to claim 2, characterized in that the source of conveying air (68) is connected to a plurality of powder feed devices (70, 126, 128).

4. Powder supply system according to one of the preceding claims, characterized by a suction device (163, 189, 190), which sucks air containing powder back from the area around the powder dispensing device (12).

5. Powder supply system according to claim 4, characterized in that the suction device (163) is connected on the outlet side to a silencer (172).

6. Powder supply system according to one of claims 2 to 5, characterized in that the powder feed device (70, 126, 128) has a conveying air separator (130) adjacent to the powder dispensing device (12).

7. Powder supply system according to one of the preceding claims, characterized in that a compressed air source (68) is connected to a fluidizing device (52) for fluidizing the powder (14) in the powder supply container (40).

8. Powder supply system according to claim 7, characterized in that the fluidizing device (52) comprises micropore bodies (52) attached to a wall of the powder supply container (40) and connected (54, 56) to the compressed air source (68), the pore size of the micropore bodies (52) being smaller than the grain size of the powder (14).

9. Powder supply system according to one of claims 2 to 8, characterized in that the powder feed device (70, 126, 128) is executed so that powder is conveyed between the powder supply container (40) and the powder dispensing device (12) by plug transportation.

10. Powder supply system according to claim 9, characterized in that the conveying air source (68) and the cross-section of a powder feed line (70, 128) are coordinated to one another so that the air velocity is roughly twice as great as the average velocity of the powder plugs (14).

11. Powder supply system according to one of the preceding claims, characterized in that the powder feed device (70, 126, 128) comprises a powder flow distributor (126), which is executed so that it releases optionally the powder flow from at least one selected powder supply container (40) to a selected powder dispensing device (12), a plurality of powder supply containers (40) and/or a plurality of powder dispensing devices (12) being present.

12. Powder supply system according to claim 11, characterized in that a plurality of powder supply containers (40) is assigned to the powder flow distributor (126), which containers contain powder of different composition.

13. Powder supply system according to claim 11 or 12, characterized in that the powder flow distributor (126) comprises a first distributor part (92) connected to the powder dispensing devices (12) and a second distributor part (80) connected to the at least one powder supply container (40) as well as a drive (90, 118) for producing a relative movement between the two distributor parts (80, 92).

14. Powder supply system according to claim 13, characterized in that the first distributor part (92) has at least one powder dispensing duct (104), which is in fluid contact with the at least one powder dispensing device (12′, 12″); that the second distributor part (80) has at least one powder dispensing duct (78), which is in fluid contact with the powder supply container (40); that the distributor parts (80, 92) are movable towards one another with a drive (90, 118) in a direction of connection and a switching direction vertical to this, the drive (90, 118) having a first drive (90) acting in the switching direction and a second drive (118) acting in the connection direction; that the powder dispensing ducts (104) of the first distributor part (92) are movable into a position aligned with a powder dispensing duct (78) of the second distributor part (80) by relative movement of the two distributor parts (80, 92) in a switching direction; and that the powder dispensing ducts (78, 104) are formed such that they form sealing points (112) when the distributor parts (80, 92) are moved towards one another in the direction of connection.

15. Powder supply system according to claim 14, characterized in that one of the two distributor parts (80) has at least one blind duct (84) for closing a powder dispensing duct (104) of the other distributor part (92) when the distributor parts (80, 92) are moved towards one another.

16. Powder supply system according to claim 14 or 15, characterized in that the ducts (78, 84, 104) are located at the same radial distance from an axis of rotation (102), around which the first distributor part (92) can be turned relative to the second distributor part (80).

17. Powder supply system according to claim 16, characterized in that the rotatable distributor part (92) is executed over at least a part of its circumference as a toothed wheel (114), in which a drive pinion (116) of the drive (90, 118) engages.

18. Powder supply system according to claim 16 or 17, characterized in that a plurality of powder dispensing ducts (78) and a plurality of blind ducts (84) are provided on at least one of the two distributor parts (80), which ducts follow one another alternately in the circumferential direction around the axis of rotation (102).

19. Powder supply system according to one of claims 11 to 18, characterized in that the powder flow distributor (126) is executed such that it connects a plurality of powder dispensing devices (12) to one powder feed line (70).

20. Powder supply system according to one of the preceding claims, characterized by at least one powder refill supply container (18), which is connected closably to the powder supply container (40) via a refilling-conveying device (26, 28, 40-44, 148, 154, 163).

21. Powder supply system according to claim 20, characterized in that the refilling-conveying device (26, 28, 40-44, 148, 154, 163) has a suction device (163).

22. Powder supply system according to claim 20 or 21, characterized in that the refilling-conveying device (26, 28, 40-44, 148, 154, 163) has a feed screw (200).

23. Powder supply system according to claim 22, characterized in that the feed screw (200) is flexible.

24. Powder supply system according to one of claims 20 to 23, characterized in that a conveying line (28) of the refilling-conveying device (26, 28, 40-44, 148, 154, 163) has a refill control valve (42).

25. Powder supply system according to claim 24, characterized in that the refill control valve (42) is executed as a ball valve.

26. Powder supply system according to one of claims 20 to 25, characterized in that the refilling-conveying device (26, 28, 40-44, 148, 154, 163) has at least one conveying lance (26) dipping into the powder (14), which lance is fitted at the end of the conveying line (28) between the powder supply container (40) and the powder refill supply container (18) facing the powder refill supply container (18).

27. Powder supply system according to claim 26, characterized in that the conveying lance (26) has a supplementary air opening executed in an upper section.

28. Powder supply system according to claim 26 or 27, characterized in that the conveying lance (26) has an oblique inlet opening at its end (30) dipping into the powder (14).

29. Powder supply system according to one of the preceding claims, characterized in that the powder dispensing device (12) is connected via at least one plug-in connector (144) to the powder supply container (40) and/or a powder return device (142-172).

30. Powder supply system according to one of the preceding claims with reference back to claim 4, characterized by a powder separating device (148), which is connected on the incoming side of the suction device (103).

31. Powder supply system according to claim 30, characterized in that a first connecting line (128) between the powder dispensing device (12) and the powder supply container (40) and a second connecting line (142, 146) between the powder dispensing device (12) and the suction device (163) are executed over at least a part of their extension as coaxial lines.

32. Powder supply system according to claim 30 or 31 with reference back to claim 4, characterized in that the separating device (148) has a powder collecting vessel (148), which is connected (154) to the powder supply container (40).

33. Powder supply system according to one of claims 30 to 32, characterized by a throttle valve (152) in a connecting line (142, 146) between the powder separating device (148) and the powder dispensing device (12).

34. Powder supply system according to claim 33, characterized in that the throttle valve (152) is executed as a swivellable flap.

35. Powder supply system according to claim 34, characterized in that the flap is covered with felt.

36. Powder supply system according to one of claims 30 to 36, characterized in that the separating device (148) has a filter (166), in particular a microfilter.

37. Powder supply system according to claim 36, characterized in that the filter (166) has a folded filter medium or a plurality of filter pockets or filter hoses.

38. Powder supply system according to claim 36 or 37, characterized by a flush-back device (68, 176, 182-186) for the filter (166).

39. Powder supply system according to claim 38 with reference back to claim 2, characterized in that the flush-back device (68, 176, 182-186) and the powder feed device (70, 126, 128) are supplied by a common source of compressed air (68).

40. Powder supply system according to one of claims 30 to 39, characterized by a shut-off valve (158), which is disposed between the separating device (148) and the powder supply container (40).

41. Powder supply system according to claim 40, characterized in that the separating device (148) is arranged above the powder supply container (40) and the shut-off valve (158) has a sealing cone, which interacts with an opening (156) in the lid (48) of the powder supply container (40).

42. Powder supply system according to claim 40 or 41, characterized in that the shut-off valve (158) has a valve drive (160).

43. Powder supply system according to one of the preceding claims, characterized in that powder conveying lines (28, 70, 128, 142, 146) are flexible and powder repelling, e.g. of polyamide.

44. Powder supply system according to one of the preceding claims with reference back to claims 11 and/or 24 and/or 40, characterized in that a controller (38) is provided, which has a signal connection to a drive (90, 118) for the powder flow distributor (126) and/or a valve drive (44) of the refill control valve (42) and/or the valve drive (160, 161) of the shut-off valve (158).

45. Powder supply system according to claim 44, characterized in that the controller (38) is a programmable controller.

46. Powder supply system according to one of the preceding claims, characterized by at least one level sensor (34, 50, 136) for the level of the powder supply container (40) and/or a powder refill supply container (18) and/or a powder dispensing vessel (134) belonging to the powder dispensing device (12).

47. Powder supply system according to claim 46, characterized in that at least one level sensor comprises a light barrier.

48. Powder supply system according to claim 46 or 47, characterized in that the at least one level sensor is a capacitive level sensor.

49. Powder supply system according to one of claims 46 to 48 with reference back to claim 26, characterized in that a level sensor (34) for the level of the powder refill supply container (18) is attached to the conveying lance (26), preferably to its tip.

50. Powder supply system according to one of claims 46 to 48 with reference back to claim 44, characterized in that the controller (38) has a signal connection to the at least one level sensor (34, 50, 136).
